(19) United States
(12) Patent Application Publication
(10) Pub. No.: US 2004/0111382 A1
(43) Pub. Date: Jun. 10, 2004

(54) Pricing personal computer use based on customer demand

(76) Inventor: Stelios Haji-Ioannou, Monaco (MC)

Correspondence Address: OSTROLENK FABER GERB & SOFFEN, 1180 AVENUE OF THE AMERICAS, NEW YORK, NY, 100368403

(21) Appl. No.: 10/316,208

(22) Filed: Dec. 10, 2002

(51) Int. Cl. G06F 17/60

(52) U.S. Cl. 705/400; 705/1

(57) ABSTRACT

A computer network with a central processor and computer terminals, particularly located in a facility or Internet Café, wherein a user purchases units of computer terminal use time to obtain an access code which the user then inputs to operate one of the computer terminals. The processor stores information about the number of time units credited to an access code. The duration of a unit of time is adjusted at the time the computer terminal is used depending upon then current usage of the computer terminals in the network based on at least one of the following factors: proportion of total number of computer terminals in the network then in use, time of day, day of week, history of the foregoing criteria and prediction of future performance under those criteria. The user purchases units of time and access credits for the purchased units of time at a computer terminal in the network.

### BACKGROUND OF THE INVENTION

The present invention concerns computers, particularly networked computers, and more particularly personal computers in a network, for which computer terminal use time is leased by the users and its invention relates particularly to adjusting the use price based on designated criteria, particularly then present demand for use of computer terminals in the network.

Establishments known as “Internet Cafés” typically have in them several personal computer terminals and associated keyboards which are available to users for selected periods of time. A terminal user is typically charged a use fee for the time the user is operating the terminal and keyboard in the facility. The user fee is a preset fee for a set period of time.

The Internet Café or like facility may have at least one human attendant who can activate or enable the activation of the computer terminals and keyboards and who either keeps a record of the time period during which each computer terminal and keyboard are in use or is able to determine the start and stop times. The attendant collects the user fee at the end of the use period. Alternatively, a fee might be collected for a particular period of time at the start of the use period. In some facilities, a payment port is associated with one or more computer terminals which may accept cash, credit or debit cards or any other form of payment, and that typically activates the computer for a period of time dependent on the value of the payment.

The concept of depositing a coin or other token of value in a collection device for enabling operation of an apparatus for a set period of time is well known. It is known to lease use time on an apparatus, in set duration units of 16.1 time for a set fee per unit, e.g. a fee for each 15 minutes of use. This may be done in some Internet Café or like facilities. Other examples of leasing an apparatus in a facility for a fee for a set time include coin-box operated public telephones, operator controlled car wash or pneumatic tire inflation apparatus where the user prepays a fee and obtains use of the apparatus for a preset duration unit of time. If the user uses the apparatus for less than the full prepaid term, there is no refund for the unused time in the unit of time. As with a coin telephone, the user can prepay for several successive, preferably continuous units of time of use of the apparatus. The price of the successive units of time purchased, even successive units purchased simultaneously, may differ. For example, for use of a coin telephone, a higher price is paid for the first unit of time and lower prices are paid for successive continuous units of time.

In Internet Cafés or in other types of facilities leasing temporary use of other types of apparatus for periods of time, the inventor hereof is unaware of any adjustments in the periods of use time sold to users for a particular fee dependent upon the then current demand for use of the apparatus.

Returning to the Internet Cafés, which is the primary example of the present invention, the Internet Café or facility comprises a number of personal computer terminals and associated keyboards, each operable by a person for as long as the person wants and for a fee for the use time. All of the terminals or keyboards are connectable to the global computer network referred to as the “Internet”. The computer terminals and keyboards are used at times during a day that the user chooses and that the Internet Café is open for business, for periods of time selected by the user and usually for a fee based upon the amount of time that a user spends at an activated computer terminal and keyboard. When the user fee is collected by a human attendant, the attendant is typically entrusted to keep a record of the time of use of the computer terminal and to charge the user a specified fee for use of the computer terminal for a particular period of time, typically a preset rate. This requires an attentive attendant who is aware of the activity of each user and who honestly reports the uses and turns over the proceeds received from users to the owner or operator of the facility. Mistakes by the attendant on site due to lack of attentiveness to uses, incorrect of time, intentionally favoring or disfavoring particular customers or even possible dishonesty, can deprive the employer or owner and operator of the Internet Café of the true value for use of the computers and terminals.

An automatic payment system associated with each computer terminal to enable its use for a set time period avoids the human error potential, but makes no fee adjustment for actual usage experience of the computer terminals in the facility.

Experiences at Internet Cafés, and the like shows that there are periods when more of the available computer terminals and keyboards are in use and periods when fewer are in use, periods of higher customer demand for computer use and periods of lower demand. Typically one expects greater use during the day and lesser use late at night. But during the day, there are also periods of greater and lesser use. For example, before the start of a workday, after the workday and during the midday or lunch period, use and therefore demand for computer terminals and keyboards is expected to be higher than at other times during the workday.

### SUMMARY OF THE INVENTION

The present invention has as its primary object overcoming problems with present Internet Cafés and like facilities which have been described above.

It is an object of the invention to enable use of a computer terminal and keyboard to be rented or leased to a user for a fee for a designated period of time of use.

A major object of the invention is to either adjust the fee for a particular time period of use, or conversely, to adjust the period of time of use for a particular fee, dependent upon selected criteria.

A related object is to adjust the fee for use for a particular period of time or the use for a particular price according to customer demand for access to the computers and for use at particular times.

Another object is to make the adjustments automatically at or for the particular Internet Café or facility.

It is another object to enable such leasing of computer terminal use through automatic machine operation, without requiring an attendant at the facility having the computer terminals to either record use by users or collect use fees.

According to the primary feature of the present invention, due to automatic adjustment of the length of a unit of time for a set price per unit or, possibly, adjustment of the price for a set unit of time, the invention provides price adjustment according to user demand for access to the computer terminals at particular times.

All of the computer terminals in a particular Internet Café or other facility are connected with a central processor which periodically monitors the customer's uses of the computer terminals. The criteria to be monitored may include, but are not limited to, one or more of: the portion of the total number of computer terminals and keyboards then in use, whether that portion of the computer terminals is in use increasing or on the decreasing, the period of time a particular user has been continuously using a computer terminal and keyboard, the actual time of day, the day of the week (workday or weekend day) and other factors which the operator decides should enter into the determination of an adjustable use price for a set time period of use or an adjustable period of time for a set price.

In the preferred embodiment of the Internet Café or other facility, the user purchases a number of units of time at a preset price per unit. The user can use the purchased units of time continuously or at separated intervals. However, once use of a unit of time has begun, the user has access to that unit only for the continuous time period of the unit. If the user discontinues use of the computer terminal during the period of time of that unit, the remaining time of that unit is lost, while the remaining units remain credited to the user.

Each unit purchased by the user is a period of time. The duration of a unit is not fixed. Rather, the period of time varies depending upon at least one of the criteria noted above. For example, and without limitation, based on at least one criterion, between 8 a.m. and 9 a.m. on a typical workday, a unit may be only of 20 minutes duration; between 10 a.m. and 11:30 a.m., the unit for the same price may be of 40 minutes duration; between 11:30 a.m. and 2 p.m., the unit for the same price may be of 20 minutes duration; between 2 p.m. and 5 p.m., the unit may be of 40 minutes duration; from 5 p.m. to 7 p.m. the unit may be of 20 minutes duration; between 7 p.m. and 11 p.m., the unit may be of one hour duration; and between 11 p.m. to 7 a.m., one unit may be of a duration of the entire eight hour period. These adjustments are made automatically according to the criteria.

The invention concerns automatic adjustment of the duration of a unit of time purchased depending upon then calculated customer demand for use of the computer terminals and keyboards at the facility. That adjustment is automatic and is done periodically, and need not be dependent upon the actual time of day. The adjustment can be based on a combination of the normal duration of a unit, which is not contingent on user demand, coupled with the then experienced user demand. For example, at a period of expected high user demand, e.g. between 8 a.m. and 9 a.m., if user demand is lower than expected, the duration of a time unit may be increased.

A major purpose of the invention is to smooth the density of users, i.e. the portion of all of the computer terminals and keyboards in use, throughout the time period when the Internet Café or facility is in operation. As users learn about some of the criteria giving them shorter or longer duration time units for a particular price, at least some users may adjust the time of day of their use of a computer terminal and keyboard at the facility to maximize the duration of their purchased time units of use, and this will tend to make the computer terminal and keyboard usage more uniform. Further, more uniform use with lesser magnitude spikes in either demand or non-use will mean that a greater proportion of the computer terminals and keyboards at the facility will be in use for a greater portion of the operating day of the facility maximizing the available use time and hopefully thereby maximizing the operators' economic return on the facility.

In a preferred embodiment of the Internet Café or facility of the invention, each computer terminal and keyboard user purchases a credit of a selected number of time units for use of the computer in advance of the use. The user then draws on his time units, one unit at a time, in operating a computer terminal. In a practical example, when a user buys time units in advance, the user receives a temporary access code enabling him to access use of any of the computer terminals at the facility. The central processor at the facility has a record of the number of units credited to that access code. The user selects an available computer terminal and keyboard, inputs his access code and is able to use the computer and terminal for as many units of time as the user had purchased.

If the user ends use of his computer terminal during one of his units of time, typically, that unit of time is considered fully spent. To restart use of a computer terminal, the user must use another unit of time. The user can halt use of the computer terminal and keyboard without having used all of his credited units of time. The central processor at the Internet Café or facility will retain information as to the number of time units remaining credited to the user's access code, so that the user can return to a computer terminal at the Internet Café or facility at a later time, enter his access code in the computer terminal and have use of the remaining credited time units of use of the computer terminal or keyboard.

The central processor at the Internet Café or facility periodically adjusts the duration of the unit of time according to at least one of the above described criteria. As a practical matter, the duration of a particular unit of time should be fixed at the time that a user first accesses that unit of time. Depending upon when different users begin using their credited units of time, different users in the same facility may be using their own respective time units which have different durations. The then current time value of a unit of time and its likely value at other later times may be posted in the facility so that users will know how much time on the computer terminal and keyboard they will receive for their purchased units of time.

An Internet Café or facility may include a vending apparatus which vends time unit credits to computer terminal users. In one preferred form, a vending apparatus is placed near the entrance to the Internet Café or facility and the users purchase time unit credits at the vending apparatus. Alternatively, vending apparatus may be positioned at or near each computer terminal and need not be at a separate apparatus or located away from the computer terminal. A computer terminal user at a vending apparatus inputs into a port cash, a token of predetermined value, a credit card, a debit card, a cash card or other source of monetary value recognized by the vending apparatus and selects the number of time units to purchase and have credited to his access code. As an aid to the user in deciding how many time units to purchase, the vending apparatus itself or a nearby apparatus might post the then current duration of a purchased time unit. Upon inputting his money, et al. into a port, the user receives information as to number of units purchased, the then current value of the time units he has purchased, perhaps information as to the total amount of time that he may have available, possibly information as to the anticipated time value of the units throughout that day, to enable the user to decide when to spend his units in computer terminal use. The vending apparatus also provides the user with his personal access code, which, as noted, a central processor ties to the purchased and credited time units. The vending apparatus may issue a printed record or ticket to the customer, which would indicate the access code for the user and may indicate the number of units credited to the access code.

When the user first activates a computer terminal, the user inputs his access code. Through the central processor to which the computer terminal is connected, the computer terminal then makes available to the user the number of units credited to the access code. The central processor will determine the duration of each unit of time as the unit is about to be spent by the user. As discussed above, the user need not spend all his credited units at one time and may retain unused time units for later use, by reentering his access code at a later time, until all of the time units are spent.

The above described operation enables a user to use a computer terminal and keyboard at an Internet Café or facility for any period of time the user chooses and at a price for the computer terminal use based on the user's actual time spent at the activated terminal, and additionally based upon the then current user demand for computers at the facility and dependent upon at least one of the other criteria discussed. All of this is automated, without a need to involve any personnel who previously may have been needed in an Internet Café or facility to start and stop the use, to time the use, and to collect a fee for the use. In fact, except for reasons of security, the entire Internet Café or facility can be automatically operated without any intervention of personnel at all.

Since the duration of a unit of time may be dependent upon users' demand for computer terminals, that is, upon user density at the particular time, especially repeat users will become aware of times during a day when they might obtain longer duration use of a computer for a particular price. Some users would be persuaded by such pricing to use a computer terminal at the Internet Café or facility during a lower user density period. This would tend to smooth out the use of the computer terminals. Assuming that the Internet Café or facility computer terminals and keyboards may as a result be used at least nearly at full capacity, this would have the tendency to maximize the number of purchased units of time used by users throughout the operating day of the Internet Café or facility.

The foregoing description of an Internet Café or facility implicitly assumes that all of the computer terminals and keyboards are at a single premises or facility. However, since the computer terminals and keyboards of the invention can be connected in a network with a central processor and with devices for vending units of time to users, there is no requirement that the computer terminals and keyboards be at one premises. A network of several facilities at spaced apart locations is also possible, all communicating to a central processor which issues user access codes and keeps track of units of time credited for each access code, with time unit vending apparatus connected with the central processor. For example, several Internet Café or facilities might be in a single network. Computer terminals in a network can be placed at locations where people gather who may be interested in using the computer terminals, including without limitation waiting areas, e.g. at airports, railway stations, and the like, meeting halls, restaurants, etc. Just as pay telephones are ubiquitous, computer terminals in accordance with the present invention may become ubiquitous as well.

Other objects and features of the present invention will become apparent from the following description of a particular embodiment of the foregoing invention described in conjunction with the accompanying drawing.

### BRIEF DESCRIPTION OF THE DRAWING

FIG. 1 is a schematic flow diagram for operation of one embodiment of an Internet Café or like facility.

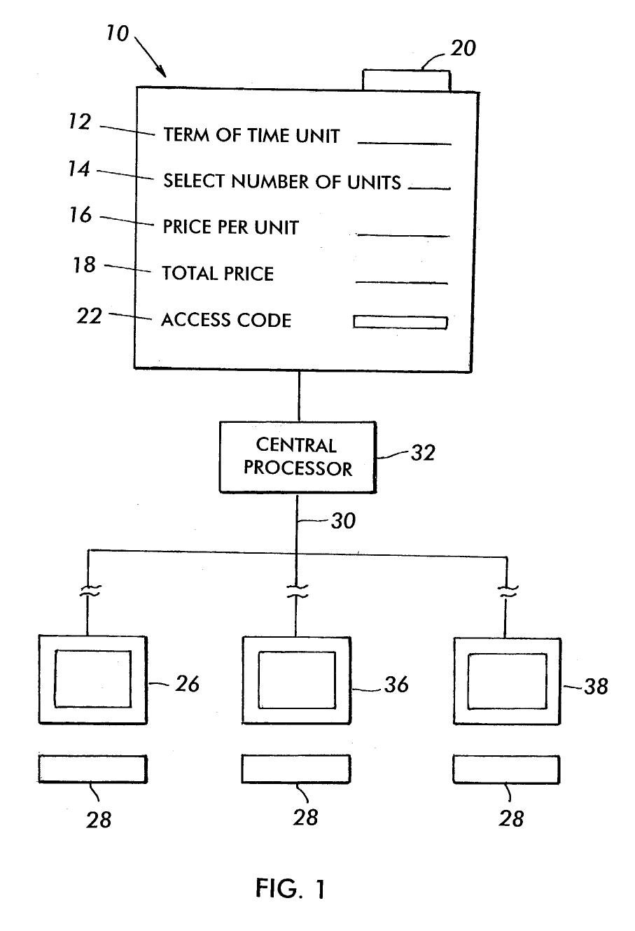

### DESCRIPTION OF A PREFERRED EMBODIMENT

One preferred embodiment of an Internet Café or like facility, that is a multiple terminal computer terminal facility, is now described. The description is in connection with the flow diagram which schematically illustrates such a facility and its method of operation by a user. Although the embodiment may be of an Internet Café premises, the invention is applicable to any network of computer terminals connected with a central processor which can monitor the use of all of the computer terminals in the connected network and can act based on that information according to the invention.

Upon entry into an Internet Café, a computer user encounters a vending device 10 at which the user prepays for credit for a selected number of units of computer terminal and keyboard use time at the facility. The vending device 10 displays at 12 the then duration or term of one purchasable unit of time and additionally may indicate the duration of units at other times during the same day. At 14, the user selects the number of units of time he wishes to purchase. The price per unit is displayed at 16 and then a total price for the purchase is displayed at 18. Once the user pays either through cash payment or through some credit or debit device installed or inserted into the payment port at 20 of the device 10, the device issues the user with an access code at 22 which the user can then enter in any computer terminal and keyboard at the facility, and the user will have available to him a credit in the number of units of time that the user had purchased.

The vending device 10 may supply the user with his access code either by displaying the access code at the device or by supplying a piece of paper printed with the access code that the user can use at the terminal so that the user may activate any available computer terminal 26 in the network by appropriate keystrokes on the keyboard 28 to provide a display of the access code and usage information on the screen. Preferably, the access code is provided only to the user and is secret to the user, which means that the user has to carry that information to the terminal.

A central processor 32 may provide password access to information including the access code so that the user might enter his password at a keyboard 28 and a respective terminal 26 would then display the information including an access code, or the password could be the access code. Other techniques for supplying an access code would be apparent to one skilled in the art.

The user can make a single purchase of several time units and use all of the purchased units credited to his access code. The user can purchase additional units at any time and have the units credited to his then access code at 22 or can obtain a new access code for the additional units. If a user is to continue with a particular use session at a terminal, it may be preferable to supplement the originally bought units rather than to start a new units purchase transaction which generates a different access code.

The Internet Café or facility includes a number of computer terminals 26, 36, 38, et al., each with a respective associated keyboard 28 which in the conventional manner operates the terminal 26, 36 or 38. Each terminal is connected either directly by cables or via wireless connections or even via the Internet at connection 30 with the central processor 32. When a user positions himself at one terminal 26 and keyboard 28, the user inputs his access code and through the connection 30 to the central processor 32, the computer terminal 26 and keyboard 26 are activated. The user possibly receives an indication of the number of units and/or even the amount of time those units may be converted to, and is able to operate the terminal 26 at which he is located. The user can connect to the Internet or perform any function locally which the computer can do. The user's credits pay for the time during which the computer terminal is activated. It is also possible to limit the charges against a user's unit of time to the time that the computer terminal is connected to the Internet through a browser, and the time while the computer is not connected to the browser during that one user session would not be charged against the user's unit of time.

The port 20 for receiving the payment may be at a vending device located at or on a computer terminal, not at a remote vending apparatus. The information shown on the vending device 10 may instead be displayed on the screen of the computer through appropriate programming of the central processor 32.

Because all of the terminals 26, 36, 38, et al. are connected to the same processor 32, the processor monitors the state of usage of the computer terminals at any time, stores that information and acts on that information according to a program and particularly an algorithm stored in the processor.

An important feature of the invention is the adjustment of the length of time or the duration of a credited unit of time dependent upon several criteria, including the clock time of day, the day of the week, and the proportion of the terminals 26, 36, 38, et al. connected with the processor 32 that are then in use, the number of users per unit of time, i.e. not the number of units used over a period of time, but the number of different access codes that have been used to activate the terminals during the period of time, which is indicative of customer density, plus stored information concerning each such activity in a previous period of time and a measure of the rate of change to the present condition, and perhaps the algorithm could make some prediction of use of the terminals in the near future based upon experience. Based on at least some of the foregoing criteria, but primarily on the actual or anticipated number of users or user density at a particular time, the then current duration of a unit of time may be adjusted. At a time of higher density use, when all the terminals 26, 36, 38 et al. are in use, and customer density is greater, the central processor will shorten the duration of a time unit and the vending apparatus will inform the user that the user's units then about to be used will be of shorter duration, for example 20 minutes in length. If only two of the three terminals 26, 36, 38 shown in the example in the Figure are in use, namely terminals 26 and 36, the user density is lower and the central processor 32 may extend the length of time or the duration of the time unit to 40 minutes, for example. This too will be displayed at the vending apparatus. With one terminal 26 activated, the duration of the unit might be extended by the processor to an hour. Appropriate adjustments are made for a network with larger numbers of terminals, and the duration of a unit may be set at any number of minutes or hours, as have been programmed in the algorithm in the processor.

At the conclusion of a computer use session, the user turns off the terminal and keyboard or otherwise exits the use session. The central processor 32 had charged the user's access code with the time units used and stores a credit of any remaining time units to the user's access code. The user can use those time unit credits at a future session, by inputting his access code in any terminal in the network connected with the central processor. A user can add to the number of units credited to his access code number or purchase new units under a different access code.

Because of the varying duration of the time units of computer terminal use, if a user has freedom or discretion to choose when he uses a terminal in the network to use his credit of time units, some users may select a time period when their units have a greater time value, i.e. a period generally of lesser use of the computer terminals connected with the network. This will have a tendency to smooth out the demand for use of the computer terminals in the Internet Café or facility, to make the density of users more uniform and to improve utilization of the computers and hopefully improve the Internet Café or network profitability.

An important factor in increasing profitability of the Internet Café or network is that no persons are required for collecting individual payments from users or for monitoring the duration of user's use or for adjusting the duration of a unit of use, since the central processor does this all automatically once it is properly programed and operating on the correct algorithm.

The foregoing embodiment uses a fixed price per unit of time and adjusts the duration of a time unit. Since time and price are here related, the same method and apparatus may instead be adapted by one skilled in the art for the processor to sell fixed duration of time units, e.g. 15 minutes duration, and to vary the price of the unit depending on the time of use. But, this would tend to make more difficult the advance purchases of units to be used later at not determined times and when user density is not yet known.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method of vending use time on a plurality of computer terminals in a common network, depending upon at least one factor related to user demand for use of computer terminals in the network, the method comprising:
for a plurality of computer terminals connected in a network to a central processor programmed with an algorithm, detecting the number of computer terminals in the network then operating and comparing the number of computer terminals then operating with the entire plurality of the computer terminals available for operation and connected with the processor in the network;
offering to users a use of a computer terminal in the network for a unit of time at a price per unit of time;
adjusting at least one of the duration of the unit of time for the price or the price for a unit of time of fixed duration, at the time the computer terminal is used, according to the at least one factor in the algorithm in the central processor including the comparison of the number of terminals in use with the entire plurality of terminals;
enabling a user to purchase, in advance of use of the computer terminal, credit for a number of the units of time of use of a computer terminal in the network by the user paying a fee based upon the number of the units of time to be purchased;
upon a user purchasing at least one unit of time, providing a user access code to the user, and the central processor crediting the number of units purchased to that user access code;
storing the credit for the number of units of time to the access code;
upon a user accessing a computer terminals in the network by the user inputting to the computer terminal the access code stored in the processor, the processor and the computer terminals making available to the user credit for the number of units of time paid for the access code;
measuring the time of use of the computer terminal accessed by a user under an access code and deducting successive units of time from the credit of the time units for that access code stored in the central processor as each unit of time is at least partially used at the computer terminal, and
continuing to store information concerning unused credit for units of time under an access code until the unit of time credited to the access code is used.

2. The method of claim 1, wherein the price for a unit of time is fixed and the duration of the unit of time is adjusted.

3. The method of claim 2, wherein the factors entered in the algorithm in the processor for determining the duration of a unit of time at any particular time include at least some of:
the proportion of the entire plurality of computer terminals in the network then in use by users, the day of the week, the clock time of day and the quantity of access code numbers activated over a period of time, historical information about any of the foregoing, and prediction of future use.

4. The method of claim 2, further comprising connecting the plurality of computer terminals to the central processor to produce a network of the computer terminals and the processor so that the central processor receives use information from all of the plurality of terminals.

5. The method of claim 1, wherein a user purchases units of time at a vending apparatus away from the computer terminals in the network, the method including supplying the user with the access code from the vending device, and the user operating the computer terminal by inputting the access code.

6. An apparatus for vending use time on a plurality of computer terminals in a common network, depending upon at least one factor related to user demand for usage of computer terminals in the network, the apparatus comprising:
a central processor programmed with an algorithm which determines the duration of a unit of time available to a user for use of a computer terminal in the network at the time the computer terminal is used based upon at least one factor including the proportion of all of the computer terminals in the network which are then in use and the algorithm being used by the processor to adjust the duration of the unit of time based upon the at least one factor; the central processor also receiving and storing information about credit for the number of units of time that is to be credited to each of a plurality of access codes;
a plurality of computer terminals each individually operable by a user and connected with the central processor to define the network, wherein the central processor is operable to activate each computer terminal for operation; each computer terminal being activateable by a user entering one of the access codes stored in the central processor for which at least one of the units of time is credited to the access code in the central processor.

7. The apparatus of claim 6, wherein the central processor stores the then current duration of a unit of time and the price per unit, and the central processor generates information concerning the total price to be paid by a user for purchasing a particular number of units of time and upon payment of that price, the central processor causes issuance of an access code to the user of the number of units.

8. The apparatus of claim 7, further comprising a payment device connected to the central processor for receiving payment from a user for credit for units of time to be credited to a user access code supplied by the central processor.

9. The apparatus of claim 7, wherein the central processor receives information about and the algorithm uses the information about at least one factor to enable the central processor to set a duration for a unit of time, the factors including at least some of:
the proportion of the entire plurality of computer terminals in the network then in use by users, the day of the week, the clock time of day and the quantity of access code numbers activated over a period of time, historical information about any of the foregoing, and prediction of future use.
